(19) United States
(12) Patent Application Publication
(10) Pub. No.: US 2005/0137846 A1
(43) Pub. Date: Jun. 23, 2005

(54) On-demand creation of Java locale source

(76) Inventors: Daniel Alan Rose, Markham (CA); Baldev Singh Soor, Markham (CA)

Correspondence Address: IBM CORPORATION;INTELLECTUAL PROPERTY LAW, 11400 BURNET ROAD, AUSTIN, TX, 78758, US

(21) Appl. No.: 11/014,158

(22) Filed: Dec. 16, 2004

(30) Foreign Application Priority Data
Dec. 23, 2003 (CA) 2453971

(51) Int. Cl. G06F 17/28; G06F 17/21

(52) U.S. Cl. 704/2; 704/7; 704/5; 704/6; 704/10

(57) ABSTRACT

A method, system, program product and signal bearing medium are provided for creating a specific Java style locale source file on demand in a computer suitable for application use. In particular the method comprises receiving a request submitted for the specific Java style locale and obtaining a plurality of localization values related to the specific Java style locale. Next operation determines a category containing elements therein within the plurality of localization values and selecting process routines dependent upon the category and the element therein. The method continues by selectively extracting the localization values pertaining to the category by the selected routines and storing the extracted localization values into a memory of the computer. The method completes with assembling the extracted information into the Java style locale source file for application use. The method further comprises determining additional categories, for each additional category, selecting process routines dependent upon the additional category containing elements therein, and selectively extracting the localization values pertaining to the additional category and the elements therein by the selected process routines; and the storing of the extracted localization values into a memory of the computer.

### FIELD OF THE INVENTION

This present invention relates generally to localization values in a computer resource file, and more particularly to creating a Java™ style locale source file from a plurality of localization values in a computer resource file.

### BACKGROUND OF THE INVENTION

In the computer software marketing and distribution industry, it is advantageous to make computer software available for use that reflects the language and culture of the intended users. A locale source file is a computer resource file typically made available by a developer of a software application to assist in accomplishing this. A locale source file may include a combination of specifications required to configure a software application program for a particular geographic and cultural market. These specifications typically include a language specification to determine and control linguistic manipulation of character strings within the application program. In addition specifications for countries, regions and territories (collectively referred to herein as “country”) define cultural conventions that may vary with languages, cultures or across countries. An example of a cultural convention is a date format identifying in which order the numerals representing day, month and year appear. Other configuration preferences, such as those used to specify mail settings or favorite icons are known in the art, but are typically not included in locale source files but may be included in other forms of personalization support.

Locale source files are usually processed into a form that can be readily used by an application program. Compilation of a source form of a locale file is one typical means of producing an object that can be accessed by an application program needing the information provided by the locale file.

Ensuring computer application program processing of information according to local cultural and geographical preferences relies on the availability of a locale object for a given combination of language and country. In order to make a locale object available there is a need to have a number of ready-made locale objects or locale source files ready to be compiled. Creating locale source files is typically tedious work requiring significant time and effort on the part of skilled programmers. Compiling objects in anticipation of use also takes time and effort as well as consuming computing resources. Locale objects that have been created but not used or are used infrequently waste computing resources and programmer time. Further locale objects themselves cannot be created until the necessary locale source files on which they are based have been built. Typically application programs also ship needed locale source or object files along with the application to ensure their existence. This replication wastes storage space. Further this practice may lead to differing results among the applications using the various copies of the locales or maintenance problems when there are differences in the locale source files or locale objects.

It is therefore desirable to have an easier more efficient centralized manner of producing locale source files for use in a computer.

### SUMMARY OF THE INVENTION

Embodiments of the present invention are provided for creating locale source files, as they are required from a plurality of localization values in a computer resource file.

An embodiment of the present invention may be employed to generate specific locale source files by request or also known as “on demand”. Results provided by embodiments of the invention typically afford easier more efficient centralized means of making selected locale source files available on a computer as required.

In accordance with an aspect of the present invention, there is provided a method for creating a specific Java style locale source file on demand in a computer suitable for application use, said method comprising, receiving a request submitted for said specific Java style locale, obtaining a plurality of localization values related to said specific Java style locale, determining a category containing elements therein within said plurality of localization values and selecting process routines dependent upon said category and said element therein, selectively extracting said localization values pertaining to said category by said selected routines, storing said extracted localization values into a memory of said computer, and assembling said extracted information into said Java style locale source file for said application use.

According to another aspect of the present invention, there is provided a system for creating a specific Java style locale source file on demand in a computer suitable for application use, said system comprising, a receiver for receiving a request submitted for said specific Java style locale, a means for obtaining a plurality of localization values related to said specific Java style locale, a means for determining a category containing elements therein within said plurality of localization values and selecting process routines dependent upon said category and said element therein, an extractor for selectively extracting said localization values pertaining to said category by said selected routines, a storage means for storing said extracted localization values into a memory of said computer, and an assembling means for assembling said extracted information into said Java style locale source file for said application use.

According to yet another aspect of the present invention, there is provided a computer program product having a computer readable medium tangibly embodying computer readable program code for instructing a computer to perform the method for creating a specific Java style locale source file on demand in a computer suitable for application use, said method comprising, receiving a request submitted for said specific Java style locale, obtaining a plurality of localization values related to said specific Java style locale, determining a category containing elements therein within said plurality of localization values and selecting process routines dependent upon said category and said element therein, selectively extracting said localization values pertaining to said category by said selected routines, storing said extracted localization values into a memory of said computer, and assembling said extracted information into said Java style locale source file for said application use.

In accordance with another aspect of the invention there is provided a signal bearing medium having a computer readable signal tangibly embodying computer readable program code for instructing a computer to perform a method for creating a specific Java style locale source file on demand in a computer suitable for application use, said method comprising, receiving a request submitted for said specific Java style locale, obtaining a plurality of localization values related to said specific Java style locale, determining a category containing elements therein within said plurality of localization values and selecting process routines dependent upon said category and said element therein, selectively extracting said localization values pertaining to said category by said selected routines, storing said extracted localization values into a memory of said computer, and assembling said extracted information into said Java style locale source file for said application use.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Preferred embodiments of the invention will now be described, by way of example, with reference to the accompanying drawings, in which:

FIG. 1 is a hardware overview of a computer system, exemplary of an embodiment of the present invention;

FIG. 2 is a block diagram of a high level view of components of an embodiment of the present invention;

FIG. 3 is flow diagram showing the overview of the process used in conjunction with the components of FIG. 2; and

FIG. 4 is a flow diagram detailing operations of elements 330 and 340 of FIG. 3.

Like reference numerals refer to corresponding components and steps throughout the drawings. It is to be expressly understood that the description and the drawings are only for the purpose of illustration and as an aid to understanding, and are not intended as a definition of the limits of the invention.

### DETAILED DESCRIPTION

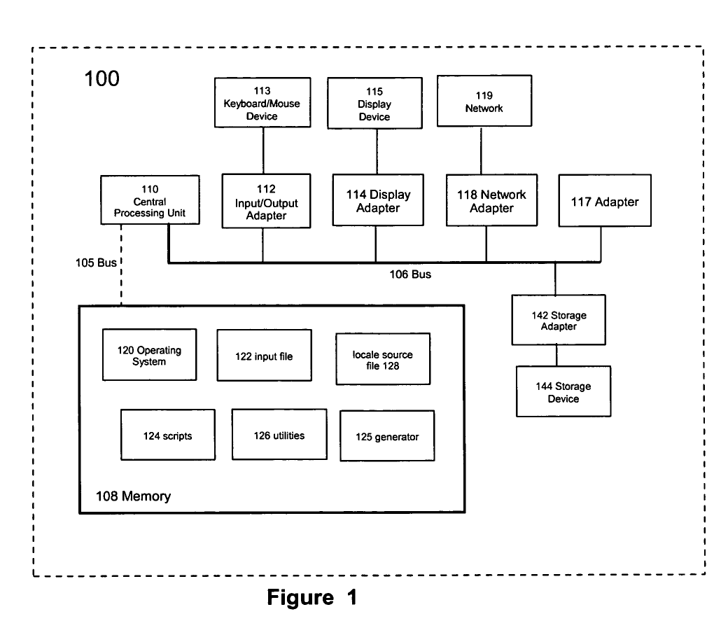

FIG. 1 depicts, in a simplified block diagram, a computer system 100 suitable for implementing embodiments of the present invention. Computer system 100 has a central processing unit (CPU) 110, which is a programmable processor for executing programmed instructions, such as instructions contained in utilities (utility programs) 126 stored in memory 108. Memory 108 can also include hard disk, tape or other storage media. While a single CPU is depicted in FIG. 1, it is understood that other forms of computer systems can be used to implement the invention, including multiple CPUs. It is also appreciated that the present invention can be implemented in a distributed computing environment having a plurality of computers communicating via a suitable network 119, such as the Internet.

CPU 110 is connected to memory 108 either through a dedicated system bus 105 and/or a general system bus 106. Memory 108 can be a random access semiconductor memory for storing language and culture data for each country and culture such as input file 122 and scripts 124. Scripts 124 provide routines to process input file 122 creating output locale source file 128. Memory 108 is depicted conceptually as a single monolithic entity but it is well known that memory 108 can be arranged in a hierarchy of caches and other memory devices. FIG. 1 illustrates that operating system 120, input file 122, scripts 124, locale source file 128 and utilities 126, may reside in memory 108.

Operating system 120 provides functions such as device interfaces, memory management, multiple task management, and the like as known in the art. CPU 110 can be suitably programmed to read, load, and execute instructions of operating system 120, scripts 124 and instructions of utilities 126. Computer system 100 has the necessary subsystems and functional components to implement testing of locale files as will be discussed later. Other programs (not shown) include server software applications in which network adapter 118 interacts with the server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology that may be used to depict test results. The Input/output adapter 112 supports devices suited for input and output, such as keyboard or mouse device 113, and a disk drive unit (not shown). Storage adapter 142 supports one or more data storage devices 144, which could include a magnetic hard disk drive or CD-ROM drive although other types of data storage devices can be used, including removable media for storing input file 122 and the output of scripts 124 being locale source file 128.

Adapter 117 is used for operationally connecting many types of peripheral computing devices to computer system 100 via bus 106, such as printers, bus adapters, and other computers using one or more protocols including Token Ring, LAN connections, as known in the art. Network adapter 118 provides a physical interface to a suitable network 119, such as the Internet. Network adapter 118 includes a modem that can be connected to a telephone line for accessing network 119. Computer system 100 can be connected to another network server via a local area network using an appropriate network protocol and the network server can in turn be connected to the Internet. FIG. 1 is intended as an exemplary representation of computer system 100 by which embodiments of the present invention can be implemented. It is understood that in other computer systems, many variations in system configuration are possible in addition to those mentioned here.

In one embodiment of the invention the process involves traversing the input file of localization information seeking values that announce categories of elements and associated values of interest. When such a category is encountered a selection of an appropriate script resource may be made. The chosen script resource is optimized for the particular category and entries within that category to be processed. For example, in an embodiment of the invention, to process a date and time category, upon locating such a category, one of a plurality of possible script modules may be invoked dependent upon that particular category being processed. A need for specialized script modules will become apparent through later discussion of the process.

Standard utilities (as in utilities 126 of FIG. 1) available on platforms are used in conjunction with the scripts. Standard utilities used include those for substring, case mapping, Unicode conversion, string and character comparison and table lookup operations. Comparisons may involve a user or may be programmatic in nature using a comparator in conjunction with reference data.

An exemplary process of an embodiment of the present invention consists of a series of operations typically as follows: “prepare”, “process”, “compare” and “generate”. Upon receipt of a request for a locale source to be created, a “prepare operation” obtains localization data as input, while a “process” operation invokes appropriate scripts to parse, and analyse the localization data to produce an output in combination with templates, as required by the category being processed, to produce a well formed output. A “compare operation” is used on the parsed data of the prepare operation to compare against selected reference strings as needed. In a “generate” operation, previous output that may have been stored as logical units will be typically combined into a locale source file. The generate operation may also be used to combine other resources such as collation specifications which are typically outside of the process being discussed. Collation specifications are separate from the formatting specifications that are the subject at hand. Additionally no character set information is provided as this has been assumed to be described inherently with the character coding of Java resources.

The “prepare process” pulls the category elements out of the localization data file syntax and environment and into a simple text form for collection into respective category entries. Output fields are used to store the collection results of the prepare process in a combination of name-value pairs.

Script modules which process the input file use announcement strings of the various categories and elements to indicate what is to be processed. Obtaining a match confirms the category to be processed and allows the main routine to selectively and more correctly process the associated values.

The result of processing is a hierarchical collection of values. The highest level is the root or locale identifier for the whole collection. The next level is the various category identifiers and finally the associated substrings and related values. Segments may also be available to use as overrides to previously provided values, using a base plus modifications approach.

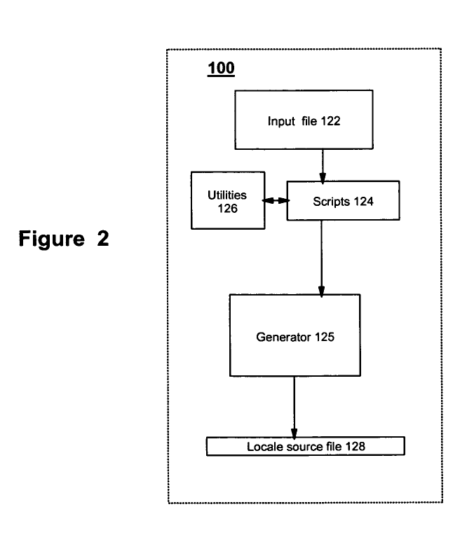

Referring to FIG. 2 is a block diagram depicting an overview of the components in an embodiment of the invention performed on an exemplary system of FIG. 1. Input file 122 is processed by scripts 124 in conjunction with utilities 126 to produce data output. This data output is passed through generate 125 to produce output of locale source file 128. Scripts 124, utilities 126 and generator 125 may be provided by hardware, software or a combination of both means. Input file 122 may be in a number of suitable forms for processing such as records with associated fields of values, tabular, linear as in pairs of values of a list ideally providing a plurality of values and associated context of use.

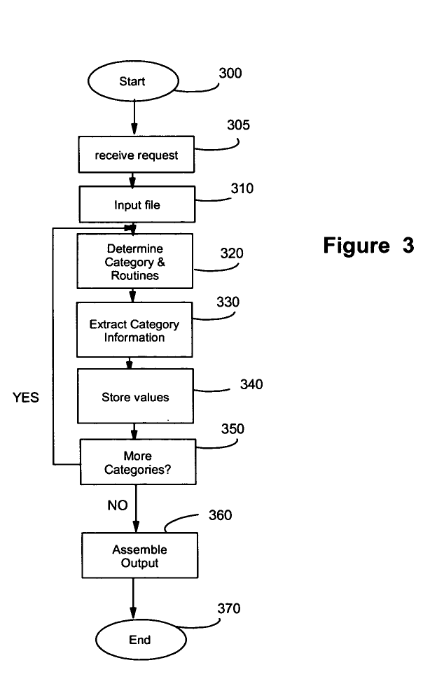

Referring now to FIG. 3 is a flow diagram showing the overall process as performed by the components as shown in FIG. 2. Processing begins in operation 300 where any necessary setup may be performed (such as importing or including other resource files upon which the output file is based) and moves to operation 305. During operation 305 a request for a specific locale source file to be created is received. Upon receipt of the request, the request is examined for completeness. A well-formed request needs to specify a desired locale. One manner is to provide an “id_ID” to correctly specify the locale. The use of such an identifier is common in the art where “id” represents language and “ID” represents country or territory. Receipt of the request causes the process to move to operation 310 during which is obtained input file 122 of FIG. 1. If there is more than one input file they are merged. For example, an input file may be a logical file consisting of many input files wherein files may be segmented to contain a portion of the required localization information. Once obtained and merged if necessary, a scripting operation 320 is performed to determine the category being processed and which routines to select based on the output category determined. Extracting specific values occurs during operation 330, wherein these values are then stored in a memory during operation 340 in a predetermined form for later use. The process is repeated for each output category required from input file 122 until all elements have been processed. Intermediate results may be stored in any form as is known in the art providing suitable retrieval such as but not limited to, arrays, vectors, tables and lists. The manner in which the output file is created may be varied so as not to restrict the process to batch collection and writing or incremental updating or adding to an open file, but may be any suitable means of managing the output.

During operation 350 a determination is made regarding existence of more categories to process. If during operation 350 it is determined that more categories exist to be processed, operations will move to operation 320 again where processing will occur as before. If there are no more categories to process, as determined during operation 350, processing will move to operation 360. During operation 360 generator 125 of FIGS. 1 and 2 assembles the output from the previous operations. Having then assembled all output which may include adding other resource files, processing moves to end at operation 370.

Details of scripting operation 330 will now be described. Scripting operation 330 uses a readily available scripting facility as is known in the art. Scripting is a form of programming which is powerful yet simple. The scripting functions are knowledgeable of the predefined syntax of input file 122 and are able to iterate through the file invoking various process modules (other specialized scripts) to perform selective actions dependent upon respective portions. For example, an input portion of locale file 122 may be typically announced according to a convention using a comment string of the form /* variable name */ wherein the name is the identifier of a specific category and element therein, such as /* month names */ denoting month name information. Contained within, are the actual localization values and information of interest as a plurality of elements or as a single element as the case may be.

Dependent on the usage context of the value being processed a respective module or scripting function is invoked to process the associated string of data. The string of data may be composed in a series of name-value pair format.

Before any locale source file can be created, a validity check should be performed on the localization data to ensure the information for the country/language pair for which the locale will be created has been verified. In this manner, the integrity of the data in the composed locale is ensured. Such a verification process is separate from the subject matter disclosed herein and will not be addressed.

The following described order is not required but merely shown as an example. The order of categories does not affect the outcome. It may be easier to understand the process by looking at the outcome and then the process to produce that outcome. The file containing a plurality of localization values can be stored in a number of suitable formats such as arrays, tables or lists. It is important however to have the information required in a form that provides efficient retrieval of requested data. For these examples it is assumed that the localization information has been provided in a single file restricted to that of a single locale. Other cases containing localization data for a plurality of locales requires a filtering step to reduce the data to the specifically requested locale of interest first. Further it is assumed that the use of other category data such as that needed by collation is by additional means such as separate files. These additional resources may be added to the output created by the described process to produce the requested locale source file.

This segment of locale source file 128 typically begins with an announcement string of the type just described and ends with a null string or close brace. Between these two statements are other statements defining the attributes of the segment in particular detail. Each element within the segment is a name-value pair having a descriptor or label as an aid in understanding the context of use. The name-value pairing also allows for more efficient processing during the creation process of the locale source file 128 from the raw localization information of input file 122 of FIG. 1. For simplicity the name of the output name-value pair may also used as a field name for example in a record oriented version of input file 122. Such a linkage is not required but is handy for this example.

The relative positioning of elements within a category is used to create a template that is then filled with extracted information during the creation process.

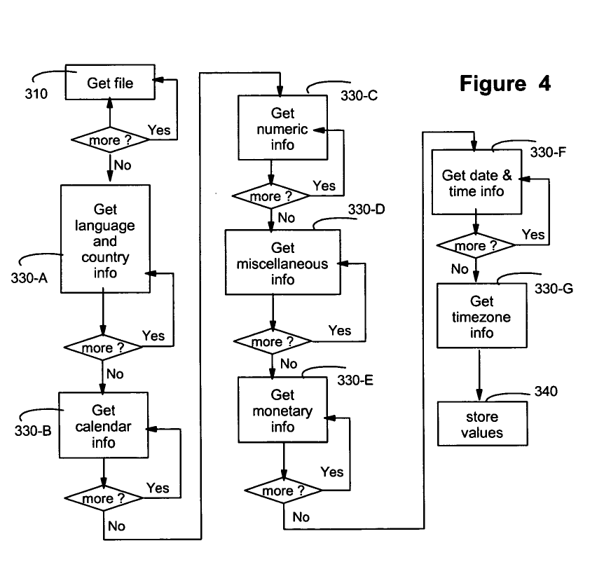

The following process steps as shown in FIG. 4 are illustrative of an embodiment of the present invention. The process steps detail operations within operations 330 and 340 of FIG. 3, particularly operation 330 beginning with operation 310. During operation 310 one or more files is obtained and merged to provide necessary localization values to satisfy the request to create a specific locale source file. Through a series of operations each category of the locale source file is addressed beginning 330-A for language and country identification processing, 330-B for calendar value processing, 330-C for numeric information processing, 330-D for miscellaneous data processing, 330-E for monetary information processing, 330-F for date and time processing and finally with 330-G for timezone information. Within each 330-xy operation is a series of smaller sub-operations denoted by 330-xy, where x is one of A-G denoting the category to which it applies and where y is a sequential number indicating the operation relative to others in the category set.

Next is operation 330-A1 during which is obtained the structure within the locale source file to be created deals with country and language information. In a first operation there is extracted the locale based on ISO codes. This element is denoted by the identifier string /* locale id based on iso codes */. To obtain the value from the input file, extract the language code from the field called “ISO639.1_Language_Code”. Convert this value to lower case if it is not already in lowercase. Next extract the extract the country code from the field called “ISO03166_Country_Code”. Convert it to upper case if it's not already in upper case. Then concatenate the language code to the country code with an (underscore) separating the two and enclose the resulting string in quotation mark. Place this string next to the string /* locale id based on iso codes */ in the locale source.

Next in operation 330-A2 extract the element identifying the Windows® based identifier string /* windows id */. If a value is not obtained place the empty string (i.e. “ ”) next to the string /* windows id */ in the output to indicate the information was not available.

Next in operation 330-A3 extract the element identifying the /* iso: 3 character lang name */. If a value is not obtained place the empty string (i.e. “ ”) next to the string /* iso: 3 character lang name */ in the output to indicate the information was not available.

Next in operation 330-A4 extract the element identifying the /* iso: 3 character country name */. If the value is not obtained place the empty string (ie. “ ”) next to the string /* iso: 3 character country name */ in the output to indicate the value was not available.

Next in operation 320-A5 obtain the value associated with identifier string /* language names */. First extract the language name from the field in the input file called “Official_Language”. Then append this string to the end of en with an (underscore) separating the two and save the string. Then extract the language code from the field called “ISO839.1_Language_Code”. Next extract the language name in native language from the field called “NTV_Language_Used”. If this field has the value N/D, then extract the language name from the field called “U_NTV_Language_Used” instead. If the language name contains any Unicode values, convert them to the form \uxxxx, where xxxx is the 4 letter code point of that character assigned by Unicode. Append the resulting language name string to the language code with the underscore character separating them. Join the resulting string from the previous step to the string created in second step with the semicolon character separating the two. Finally enclose the new string in quotation marks and place next to the string /* language names */ in the locale.

Next in operation 320_A6 obtain the value associated with identifier string /* country names */. Extract the country name from the field called “Official_Country_Name”. Next append this string to the end of en with a (underscore) character separating the two and save the string. Next extract the language code from the field called “ISO639.1_Language_Code”. Then extract the country name in native language from the field called “NTV_Country_Name”. If this field contains the value N/D, then extract the country name from the field called “U_NTV_Country_Name” instead. If the country name string contains any Unicode values, convert them to be of the form \uxxxx, where xxxx is the 4 letter code point for that character assigned by Unicode. Then append the new country name string to the language code obtained in third step, with a underscore character separating the two. Join the string from the previous step to the string from second step with a semicolon separating the two. Finally enclose the new string in quotation marks and place next to the string /* country names */ in the locale.

This completes the gathering of information for country land language codes.

To obtain information for calendaring there are a number of operations to perform to extract the various day, week and month elements. First to obtain the month names, in operation 330-B1, for the identifier strings such as 1* january */ in the output file, extract the string from the field called “NTV_january”. If this field contains the value N/D, then extract required value from field called “U_NTV_january” instead. If the string contains any Unicode values, convert them to the form \uxxxx, where xxxx is the 4-letter code point of that character assigned by Unicode. Then enclose the new string in quotation marks and place it next to the string /* january */ in the output file. Repeat this series of steps for the remaining month names.

Next in operation 330-B2, obtain the abbreviated month names, such as /* abb january */, extract the string from the field called “NTV_Abbreviated_Jan”. If this field contains the value N/D, then extract the string from the field called “U_NTV_Abbreviated_Jan” instead. If the string contains any Unicode values, convert them to the form \uxxxx, where xxxx is the 4-letter code point of that character assigned by Unicode. Then enclose the new string in quotation marks and place it next to the string /* abb january */ in the output. Then repeat the same series of steps for the remaining abbreviated month names.

Nect in operation 330-B3 obtain the days of the week or weekday names such as /* monday */, first extract the string from the field called “NTV_Monday”. If this field contains the value N/D, then extract the string from the field called “U_NTV_Monday” instead. If the string contains any Unicode values, convert them to be of the form \uxxxx, where xxxx is the 4-letter code point of that character assigned by Unicode. Next enclose the new string in quotation marks and place it next to the string /* monday */ in the output file. Next repeat this same series of steps for the remaining required weekday names.

Next in operation 330-B4 obtain the abbreviated weekday names such as /* abb monday */, extract the string from the field called “NTV_Abbreviated_Mon”. If this field contains the value N/D, then extract the string from the field called “U_NTV_Abbreviated_Mon” instead. If the string contains any Unicode values, convert them to be of the form \uxxxx, where xxxx is the 4-letter code point of that character assigned by Unicode. Then enclose the new string in quotation marks and place it next to the string /* abb monday */ in the locale. Finally repeat this same series of steps to obtain the remaining abbreviated weekday names. This completes the day and month names elements.

Next in operation 330-C1 obtain numeric format specifications such as /* decimal pattern */, first extract the positive numeric example from the field called “Numeric_Positive_Format” and the negative numeric example from the field called “Numeric_Negative_Format”. If either of these two fields contain the value N/A, skip the remaining steps of this section and put the empty string next to the string /* decimal pattern */ in the output; otherwise, continue. Next scan through both numeric examples and replace all digits (0 to 9) with the number sign (i.e. #) character symbol. For each example, find the decimal separator within the respective example and change the first number sign before it to 0. Then concatenate the two numeric examples into one string with a semicolon separating the two examples. Next enclose the new string in quotation marks and place it next to the string /* decimal pattern */ in the output.

Next in operation 330-C2 obtain the /* percent pattern */, and place next to the string /* percent pattern */ otherwise place the empty string (i.e. “ ”) next to the string /* percent pattern */ in the output to indicate the value was not obtained.

Next in operation 330-C3 obtain the /* decimal separator */, by first extracting the decimal separator from the field called “Numeric_Decimal_Separator”. If this field contains the value NONE, then skip the remaining steps of this section and place the empty string next to the string /* decimal separator */ in the locale; otherwise, continue. Convert the decimal separator located from its symbolic name to its actual character value. Enclose the character in quotation marks and place next to the string /* decimal separator */ in the output file.

Next in operation 330-C4 obtain the grouping separator, /* group (thousands) separator */, by first extracting the thousand separator from the field called “Numeric_Thousands_Separator”. If this field contains the value NONE, then skip the remaining steps of this section and print the empty string next to the string /* group (thousands) separator */ in the output; otherwise, continue. Then convert the thousand separator from its symbolic name to its actual character value. Enclose the character in quotation marks and place it next to the string /* group (thousands) separator */ in the output file.

Next in operation 330-C5 obtain the percent sign /* percent sign */and place next to the string /* percent sign */ otherwise place the empty string (i.e “ ”) next to the string /* percent sign */ in the locale, as this information was not available.

Next in operation 330-C6 obtain the /* native 0 digit */, and place the value next to string /* native 0 digit */ otherwise place the empty string (i.e. “ ”) next to the string /* native 0 digit */ in the output, as this information was not available.

Next in operation 330-C7 obtain the r pattern digit */, and place the value next to string /* pattern digit */ otherwise place the empty string (i.e. “ ”) next to the string /* pattern digit */ in the output as this information was not available.

Next in operation 330-C8 obtain the /* minus sign */, by first extracting the negative sign from the field called “Numeric_Negative_Sign”. If this field contains the value NONE, then skip the remaining steps of this section and put the empty string next to the string /* minus sign */ in the locale; otherwise, continue. Convert the negative sign from the symbolic name located to its actual character value. Enclose the negative sign in quotation marks and place it next to the string /*minus sign */ in the output file.

Next in operation 330-C9 obtain the /* exponential */, value and place it next to string /* exponential */ otherwise place the empty string (i.e. “ ”) next to the string /* exponential */ in the output, as this information was not available.

This completes the gathering of numeric formatting specifications.

Next in operation 330-D1 obtain miscellaneous useful information such as the list item separator /* list separator */ and place the value retrieved next to the string /* list separator */ otherwise place the empty string (i.e. “ ”) next to the string /* list separator */ in the output, as this information was not available.

Next in operation 330-E1 obtain monetary information such as the currency pattern, /* currency pattern */, by first extracting the positive and negative monetary example from the fields called “Monetary_NAT_Positive_Format” and Monetary_NAT_Negative_Format” respectively. If either of these two fields contains the value N/A, then skip the remaining steps and put the empty string next to the string /*currency pattern */ in the locale; otherwise, continue. For each string, scan through the example found and replace all the digits (0 to 9) by the number sign character. Then find the decimal separator in the example and change the first number sign preceding it to 0 as well as all the number sign after it. Then join the two examples together into one string with a semicolon in the middle. Enclose the new string in quotation marks and place it next to the string /* currency pattern */ in the output file.

Next in operation 330-E2 obtain the r local currency symbol */, by first extracting the currency symbol from the field called “Monetary_NTV_Currency_Symbol”. If this field contains the value N/D, then extract it from the field called “U_Monetary_NTV_Currency_Symbol” instead. If the currency symbol string contains any Unicode value, convert them to the form uxxxx, where xxxx is the 4-letter code point of that character assigned by Unicode. Then enclose the currency symbol in quotation mark and place them next to the string/* local currency symbol */ in the output file.

Next in operation 330-E3 obtain the /* intl currency symbol */, by first extracting the ISO 4217 Alphabetic Currency Code from the field called “Monetary_ISO4217_Alpha_Code”. If this field contains the value N/A, then skip the remaining steps of this section and print the empty string next to the string /* intl currency symbol */ in the locale; otherwise, continue. Append the Unicode value \u0020 to the end of the currency code. Then enclose the new string in quotation mark and print it next to the string /* intl currency code */ in the locale.

Next in operation 330-E4 obtain the /* monetary decimal separator */, first extract the decimal separator from the field called “Monetary_NAT_Decimal_Separator”. If this field contains the value N/A, then skip the remaining steps of this section and put the empty string next to the /*monetary decimal separator */ string in the locale; otherwise, continue. Convert the decimal separator from its symbolic name to its actual character value. Then enclose the character in quotation marks and place it next to the string /* monetary decimal separator */ in the output file.

This completes the gathering of monetary information.

Next in operation 330-F1 obtain the variety of date and time formatting specifications such as /* am marker; default is AM */, by first extracting the morning string from the field called “Time_NTV_Morning_String”. If this field contains the value N/A, then skip the remaining steps of this section and put the empty string next to the string /* am marker; default is AM */ in the locale. Else if it contains the value N/D instead, then extract the morning string from the field called “U_Time_Morning_String” instead. If the string contains any Unicode values, then convert them to the form \uxxxx, where xxxx is the 4-letter code point of the character assigned by Unicode. Then enclose the new string in quotation marks and place it next to the string /* am marker; default is AM */ in the output file.

Next in operation 330-F2 obtain the time of day indicator /* pm marker; default is PM */, first extract the afternoon string from the field called “Time_NTV_Afternoon_String”. If this field contains the value N/A, then skip the remaining steps of this section and put the empty string next to the string /* pm marker; default is PM */ in the locale. However, if the value contained in the field is N/D instead, then extract the afternoon string from the field called “U_Time_Afternoon_String” instead. If the afternoon string contains any Unicode values, then convert them to the form \uxxxx, where xxxx is the 4-letter code point of that character. Then enclose the new string in quotation marks and place it next to the string /* pm marker; default is PM */ in the output file.

Next in operation 330-F3 obtain the era names such as that contained within the /* era strings */, and place next to string /* era strings */ otherwise place the empty string next to the string /* era strings */ in the output, as this information was not available.

Next in operation 330-F4 obtain the /* full time pattern */, by first extracting the string in the field called “Time_NTV_Full_Format”. If this field contains the value N/D, then extract the string from the field called “U_Time_NTV_Full_Format” instead. If the string contains any Unicode value, then convert them to the form \uxxxx, where xxxx is the 4-letter code point for the character. Then parse the string to determine the location of the hour, minutes, seconds, am/pm string, and timezone name if it exists. Then replace each by their corresponding value, wherein hour is replaced by h; minutes is replaced by m; seconds is replaced by s; AM/PM string is replaced by a, and Timezone name is replace by z. Then enclose the string in quotation marks and place it next to the string /* full timepattern */ in the output.

Next in operation 330-F5 obtain the /* long time pattern */, from the localization values and place next to string /* long time pattern */ otherwise copy the output string for the /* full time pattern */ and place it next to the string /* long time pattern */ as this information was not available.

Next in operation 330-F6 obtain the /* default time pattern */, by first extracting the string in the field called “Time_NTV_Common_Format”. If this field contains the value N/D, then extract it from the field called “U_Time_NTV_Common_Format” instead. Then repeat second, third and fourth steps of the full time pattern operation. Enclose the string in quotation marks and place it next to the string /* default time pattern */ in the output file.

Next in operation 330-F7 obtain the short time pattern /* short time pattern */, by first extracting the string in the field called “Time_Short_Format”. Repeat the second, third and fourth steps of the full time pattern operation for this string. Then enclose the string in quotation marks and place next to the string /* short time pattern */ in the output file.

Next in operation 330-F8 obtain the full date pattern /* full date pattern */, by first extracting the string in the field called “Date_NTV_Full_Format”. If this field contains the value N/D, then extract it from the field called “U_Date_NTV_Full_Format” instead. If the string contains any Unicode value, then convert them to be of the form \uxxxx, where xxxx represents the 4-letter code point for the character. Then parse the string to determine the location of the day, month, year and weekday name, and replace each with their corresponding value as follows: Weekday name is replaced by EEEE; Month is replaced by MMMM; Date is replaced by D; and Year is replaced by YYYY. Then enclose the string in quotation mark and place next to the string /* full date pattern */ in the output file.

Next in operation 330-F9 obtain the /* long date pattern */, by first extracting the string in the field called “Date_NTV_Long Format”. If this field contains the value N/D, then extract it from the field called “U_Date_NTV_Full_Format” instead. Repeat second and third steps of the full date pattern for this string. Then enclose the string in quotation marks and place next to the string /* long date pattern */ in the output file.

Next in operation 330-F10 obtain the default date pattern, /* default date pattern */, by first extracting the string in the field called “Date_NTV_Common_Format”. If this field contains the value N/D, then extract it from the field called “U_Date_NTV_Common_Format” instead. Then repeat the second and third steps of the full date pattern for this string. Next enclose the string in quotation marks and place next to the string /* default date pattern */ in the locale.

Next in operation 330-F11 obtain the short date pattern /* short date pattern */, by first extracting the string in the field called “Date_NTV_Short_Format”. If this field contains the value N/D, then extract it from the field called “U_Date_NTV_Short_Format” instaed. Repeat second and third steps of the full date pattern for this string. Next enclose the string in quotation marks and place next to the string /* short date pattern */ in the output file.

Next in operation 330-F12 obtain the /* date-time pattern */, by first extracting the string in the field called “Date_and_Time_Format”. If this field contains the value N/A, then place the empty string next to the string /* date-time pattern */ in the locale; otherwise, continue. Scan through the string for the words “date” and “time”. Next replace each by their corresponding value as follows: date is replaced by % 1 and time is replaced by %0. Then enclose the string in quotation marks and place next to the string /* date-time pattern */ in the output file.

Next in operation 330-F13 obtain the /* first day of week */, by first extracting the string from the field called “Calendar_First_Day_Of_Week”. Then replace this string by its corresponding numeric value. (i.e. Sunday is 1, Monday is 2 and so on.) Next enclose the numeric value in quotation marks and place next to the string /* first day of week */ in the output file.

Next in operation 330-F14 obtain the minimum number of days in the first week, /* min days in first week */, by first extracting the value from the field called “Calendar_DaysInFirstWeekOfYear”. Then enclose the value in quotation marks and place next to the string /* min days in first week */ in the output file.

This completes the time and date information gathering.

To obtain timezone information, such as the timezone identifier /* id */, first in operation 330-G1 extract the string from the field called “Timezone_ShortName_{—}1”. If this field contains the value N/A, then skip the remaining steps of this section and put the empty string next to the string /* id */in the locale; otherwise, continue. Then enclose the string in quotation marks and place next to the string /* id */ in the output file.

Next in operation 330-G2 obtain the timezone offset from GMT, /* gmt offset */, by first extracting the value from the field called “Timezone_Offset_{—}1”. Then enclose it in quotation marks and place next to the string /* gmt offset */ in the output file.

Next in operation 330-G3 obtain the daylight savings specifications, /* daylight saving delta */, first if the value contained in the field called “Timezone_DST_Used_{—}1” is NO, then skip the remaining steps of this section and place the empty string next to the string /* daylight saving delta */ in the locale; otherwise, extract the value from the field called “Timezone_DST_Offset_{—}1” and continue. Then enclose the value in quotation marks and place next to the string /* daylight saving delta */ in the output file.

Next in operation 330-G4 obtain the abbreviated timezone information, /* abbreviated timezone name */, by first extracting the string from the field called “Timezone_ShortName_{—}1”. If this field contains the value N/A or NONE, then skip the remaining steps of this section and place the empty string next to the string /* abbreviated timezone name */ in the output file; otherwise, continue. Next enclose the string in quotation mark and print it next to the string /* abbreviated timezone name */ in the output file.

Next in operation 330-G5 obtain the abbreviated daylight savings name specification, /* abb. daylight-savings name */, by first extracting the string contained in the field called “Timezone_DST_Used_{—}1”. If this string is NO, then print the empty string next to the string /* Abb. Daylight-savings name */in the output file; otherwise, extract the string contained in the field called “Timezone_DST_ShortName_{—}1”. Then enclose the string in quotation marks and place next to the string /* abb daylight-savings name */ in the output file.

Next in operation 330-G6 obtain the full timezone name specification, /* full timezone name */, by first extracting the string contained in the field called “Timezone_FullName_{—}1”. If the string is N/A or NONE, then place the empty string next to the string /* full timezone name */ in the output file; otherwise enclose the string in quotation marks and place this string in the output file.

Next in operation 330-G7 obtain the full daylight savings names, /* full daylight-savings name */, by first extracting the string contained in the field called “Timezone_DST_Used_{—}1”. If this string is NO, then print the empty string next to the string /* full daylight-savings name */ in the locale; otherwise, extract the string contained in the field called “Timezone_DST_FullName_{—}1” and continue. If the extracted string is N/A or NONE, place the empty string next to the string /* full daylight-saving name */ in the locale; otherwise, enclose it in quotation marks and place this string in the output file instead.

Next in operation 330-G8 obtain a representative city name within the timezone, /* representative city in timezone */, by first extracting the string value contained in the field called “Timezone_Representative_City_{—}1”. If this field is N/A or NONE, then place the empty string next to the string /* representative city in timezone */ in the output file; otherwise, enclose the string in quotation mark and place this string in the output file instead.

Next in operation 330-G9 obtain the start month name, /* start month */, by first extracting the string contained in the field called “Timezone_DST_Used_{—}1”. If this field has the string NO as its value, then set the empty string as the value for the /* start month */ in the output file. If this field has the string YES, then extract the value in the field called “Timezone_DST_Rules_{—}1”. If this field has the value RULES BASED, then extract the string in the field called “Timezone_DST_StartMonth”. Then enclose the string in quotation marks and place next to the string /* start month */ in the locale.

Next in operation 330-G10 obtain the start date of the month, /* start date in month */, by first extracting the string contained in the field called “Timezone_DST_Used_{—}1”. If this field has the string NO as its value, then place the empty string next to /* start date in month */ in the locale; otherwise, extract the value in the field called “Timezone_DST_Rules_{—}1”. If this field has the value RULES BASED, then place the empty string next to /* start date in month */ in the locale; otherwise, enclose the string in quotation marks and place this string in the output file.

Next in operation 330-G11 obtain the start day of the week, /* start day-of-week in month */, by first extracting the string contained in the field called “Timezone_DST_Used_{—}1”. If this field has the value NO, then print the empty string next to /* start day-of-week in month */ in the locale; otherwise, extract the value in the field called “Timezone_DST_StartWeek”. Then enclose the string in quotation marks and place next to the string /* start day-of-week in month */ in the output file.

Next in operation 330-G12 obtain the start day of the week, /* start day-of-week */, by first extracting the string in the field called “Timezoe_DST_Used_{—}1”. If this field has the value NO, then place the empty string next to the string /* start day-of-week */ in the output file; otherwise, extract the string in the field called “Timezone_DST_StartDay_{—}1”. Then enclose the string in quotation marks and place next to the string /* start day-of-week */ in the output file.

Next in operation 330-G13 obtain the end month for daylight savings, /* end month */, by first extracting the string in the field called “Timezone_DST_Used_{—}1”. If this field has the value NO, then print the empty string next to the string /* end month */ in the locale; otherwise, extract the string contained in the field called “Timezone_DST_EndMonth_{—}1”. Then enclose the string in quotation marks and place next to the string /* end month */ in the output file.

Next in operation 330-G14 obtain the end date in the month, /* end date in month */, by first extracting the string in the field called “Timezone_DST_Used_{—}1”. If this field has the value NO, then place the empty string next to the string /* end date in month */ in the output file; otherwise, extract the string in the field called “Timezone_DST_Rules_{—}1”. If this string has the value BY DECREE, then extract the string in the field called “Timezone_DST_EndDate_{—}1”; otherwise, place the empty string next the string /* end date in month */ in the output file. Then enclose the string in quotation marks and place it next to the string /* end date in month */ in the output file.

Next in operation 330-G15 obtain the end day of the week within the month, /* end day-of-week in month */, by first extracting the string in the field called “Timezone_DST_Used_{—}1”. If this field has the value NO, then place the empty string next to the string /* end day-of-week in month */ in the output file; otherwise, extract the string in the field called “Timezone_DST_EndWeek_{—}1”. Then enclose the string in quotation marks and place next to the string /* end day-of-week in month */ in the output file.

Next in operation 330-G16 obtain the end day of the week, /* end day-of-week */, by first extracting the string in the field called “Timezone_DST_Used_{—}1”. If this field has the value NO, then place the empty string next to the string /* end day-of-week */ in the output file; otherwise, extract the string in the field called “Timezone_DST_EndDay”. Then enclose the string in quotation marks and place next to the string /* end day-of-week */ in the output file.

This completes the timezone information gathering.

Other forms of input files using differing arrangements may lead to other approaches to keeping related information together. The simple form of name and value pairs has been used in these examples as a means of keeping the value with a context of use.

The localization information does not have to be close to the extraction functions but it may be more efficient to do so. Remote files can be used successfully in these types of operations provided the network has sufficient speed and capacity. The localization may be amalgamated into one consolidated file of data or it may be partitioned according to specific locale information or specific types of information such as monetary formatting specifications across locales.

Although the invention has been described with reference to illustrative embodiments, it is to be understood that the invention is not limited to these precise embodiments, and that various changes and modifications may be effected therein by one skilled in the art. All such changes and modifications are intended to be encompassed in the appended claims.

1. A method for creating a specific Java style locale source file on demand suitable for application use in a computer, said method comprising:
receiving a request submitted for said specific Java style locale;
obtaining a plurality of localization values related to said specific Java style locale;
determining a category containing elements therein within said plurality of localization values and selecting process routines dependent upon said category and said element therein;
selectively extracting said localization values pertaining to said category by said selected routines;
storing said extracted localization values into a memory of said computer; and
assembling said extracted information into said Java style locale source file for said application use.

2. The method of claim 1, further comprising determining additional said categories, for each said additional category:
selecting process routines dependent upon said additional category containing elements therein;
selectively extracting said localization values pertaining to said additional category and said elements therein by said selected process routines; and
storing said extracted localization values into said memory of said computer.

3. The method of claim 1, wherein said plurality of localization values is sufficient to populate at least one said category of said specific Java defined locale.

4. The method of claim 3, wherein said assembling said extracted information further comprises addition of a collation resource file.

5. The method of claim 4, wherein said request is initiated by at least one of a manual means involving a user and a programmatic means.

6. A computer program product having a computer readable medium tangibly embodying computer readable program code for instructing a computer to perform the method of claim 1.

7. A computer program product having a computer readable medium tangibly embodying computer readable program code for instructing a computer to perform the method for creating a specific Java style locale source file on demand in a computer suitable for application use, said method comprising:
receiving a request submitted for said specific Java style locale;
obtaining a plurality of localization values related to said specific Java style locale;
determining a category containing elements therein within said plurality of localization values and selecting process routines dependent upon said category and said element therein;
selectively extracting said localization values pertaining to said category by said selected routines;
storing said extracted localization values into a memory of said computer; and
assembling said extracted information into said Java style locale source file for said application use.

8. A system for creating a specific Java style locale source file on demand in a computer suitable for application use, said system comprising:
a receiver for receiving a request submitted for said specific Java style locale;
a means for obtaining a plurality of localization values related to said specific Java style locale;
a means for determining a category containing elements therein within said plurality of localization values and selecting process routines dependent upon said category and said element therein;
an extractor for selectively extracting said localization values pertaining to said category by said selected routines;
a storage means for storing said extracted localization values into a memory of said computer; and
an assembling means for assembling said extracted information into said Java style locale source file for said application use.

9. The system of claim 8, further comprising means for determining additional said categories, for each said additional category:
selecting process routines dependent upon said additional category containing elements therein;
selectively extracting said localization values pertaining to said additional category and said elements therein by said selected process routines; and
storing said extracted localization values into said memory of said computer.

10. The system of claim 9, wherein said plurality of localization values is sufficient to populate at least one said category of said specific POSIX defined locale.

11. (canceled)

12. (canceled)

13. (canceled)

14. A signal bearing medium having a computer readable signal tangibly embodying computer readable program code for instructing a computer to perform the method of claim 1.

15. A signal bearing medium having a computer readable signal tangibly embodying computer readable program code for instructing a computer to provide the means of claim 8.

16. A signal bearing medium having a computer readable signal tangibly embodying computer readable program code for instructing a computer to perform a method for creating a specific Java style locale source file on demand in a computer suitable for application use, said method comprising:
receiving a request submitted for said specific Java style locale;
obtaining a plurality of localization values related to said specific Java style locale;
determining a category containing elements therein within said plurality of localization values and selecting process routines dependent upon said category and said element therein;
selectively extracting said localization values pertaining to said category by said selected routines;
storing said extracted localization values into a memory of said computer; and
assembling said extracted information into said Java style locale source file for said application use.

17. The signal bearing medium having a computer readable signal tangibly embodying computer readable program code of claim 16, further comprising program code for instructing a computer to determine additional said categories, for each said additional category:
selecting process routines dependent upon said additional category containing elements therein;
selectively extracting said localization values pertaining to said additional category and said elements therein by said selected process routines; and
storing said extracted localization values into said memory of said computer.
